(19) United States
(12) Patent Application Publication
(10) Pub. No.: US 2026/0032069 A1
(43) Pub. Date: Jan. 29, 2026

(54) SYSTEM AND METHOD OF AI-ENHANCED EVALUATION OF NETWORK PERFORMANCE USING A MEAN QUALITY INDEX

(71) Applicant: Jeffrey HORNER, Leesburg, VA (US)

(72) Inventor: Jeffrey HORNER, Leesburg, VA (US)

(21) Appl. No.: 19/255,448

(22) Filed: Jun. 30, 2025

Related U.S. Application Data
(60) Provisional application No. 63/676,154, filed on Jul. 26, 2024.

(51) Int. Cl. H04L 43/08; G06F 40/30

(52) U.S. Cl. CPC H04L 43/08; G06F 40/30

(57) ABSTRACT

An approach for collecting network (e.g., Internet) performance metrics from an end-user perspective is disclosed. The approach comprises collecting, by at least one objective agent, a plurality of connection parameters relating to network service quality, wherein the plurality of collected connection parameters include throughput measurements relating to download speed and upload speed. The approach also comprises determining a mean quality index (MQI) score based on the plurality of collected connection parameters, wherein the MQI score is indicative of the network service quality from a user perspective.

### RELATED APPLICATIONS

This application claims the benefit of U.S. Provisional Patent Application No. 63/676,154 titled “System, Method, and Device for Utilizing Artificial Intelligence to Actively Manage Internet Connectivity and Service Performance,” filed Aug. 8, 2024, the entire disclosure of which is hereby incorporated by reference herein.

### BACKGROUND

Conventional approaches for Internet performance evaluation rely heavily on isolated key performance indicators (KPIs), such as download speed, latency, or packet loss, often collected by embedded or client-side testing agents. In many cases, these metrics or associated network statistics are fragmented, inconsistent across platforms, and lack contextual insight.

### SOME EXAMPLE EMBODIMENTS

Therefore, there is a need for an approach that can emerging technologies, namely artificial intelligence (AI), to seamlessly integrate and analyze both objective data from network performance metrics and subjective data from customer reviews, thereby enhancing operational decision-making and boosting customer satisfaction.

According to one embodiment, a method comprises collecting, by at least one objective agent, a plurality of connection parameters relating to network service quality, wherein the plurality of collected connection parameters include throughput measurements relating to download speed and upload speed. The method also comprises determining a mean quality index (MQI) score based on the plurality of collected connection parameters, wherein the MQI score is indicative of the network service quality from a user perspective. The determination of the MQI score includes normalizing and weighting the plurality of collected connection parameters, and mapping the normalized and weighted connection parameters to a fixed performance scale.

According to another embodiment, a system comprises at least one processor, and at least one memory including computer program code for one or more computer programs, the at least one memory and the computer program code configured to, with the at least one processor, cause, at least in part, the system to collect, by at least one objective agent, a plurality of connection parameters relating to network service quality, wherein the plurality of collected connection parameters include throughput measurements relating to download speed and upload speed. The system is also caused to determine a mean quality index (MQI) score based on the plurality of collected connection parameters, wherein the MQI score is indicative of the network service quality from a user perspective, wherein the determination of the MQI score includes normalizing and weighting the plurality of collected connection parameters, and mapping the normalized and weighted connection parameters to a fixed performance scale. The system is also caused to collect, by at least one subjective agent, user-facing feedback data from one or more textual sources relating to the network service quality. Additionally, the system is further caused to ingest content, wherein the content includes one or more combination of online review, support transcript, and social media forum. The system is also caused to generate a Sentiment Momentum (SM) score representing a vectorized model of user sentiment based on the collected user-facing feedback data and the ingested content. Further, the system is caused to selectively modify the MQI score based on the generated SM score.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between the service provider and mobile device with actions being performed on both sides.

For various example embodiments, the following is applicable: an apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of an Artificial Intelligence (AI)-driven Internet connectivity and performance platform, according to one embodiment;

FIG. 2 is a diagram of the components of the AI-driven Internet connectivity and performance platform of FIG. 1, according to one embodiment;

FIGS. 3A and 3B are flowcharts of processes for generating a Mean Quality Index (MQI) by the AI-driven Internet connectivity and performance platform of FIG. 1, according to one embodiment;

FIGS. 4A and 4B are diagrams of the functional flow among the objective agents (OAs) and subjective agents (SAs), according to various embodiments;

FIGS. 5A-5C are diagrams relating to MQI generated by the AI-driven Internet connectivity and performance platform of FIG. 1, according to one embodiment;

FIGS. 6A and 6B are diagrams of a GUI relating to MQI to online review scraping and MQI versus subjective reviews, respectively, according to one embodiment;

FIG. 7 is a diagram of a GUI relating to the subjective agent (SA) generating a sentiment score, according to one embodiment;

FIG. 8 is a diagram of a neural network that can be implemented by the AI-driven Internet connectivity and performance platform of FIG. 1, according to one embodiment;

FIG. 9 is a diagram of hardware that can be used to implement various example embodiments;

FIG. 10 is a diagram of a chip set that can be used to implement various example embodiments; and

FIG. 11 is a diagram of a mobile terminal (e.g., handset) that can be used to implement various example embodiments.

### DESCRIPTION OF SOME EMBODIMENTS

Examples of a method, apparatus, and computer program for computing a Mean Quality Index (MQI) score that quantifies network (e.g., Internet) performance based on objective wireless connection metrics are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

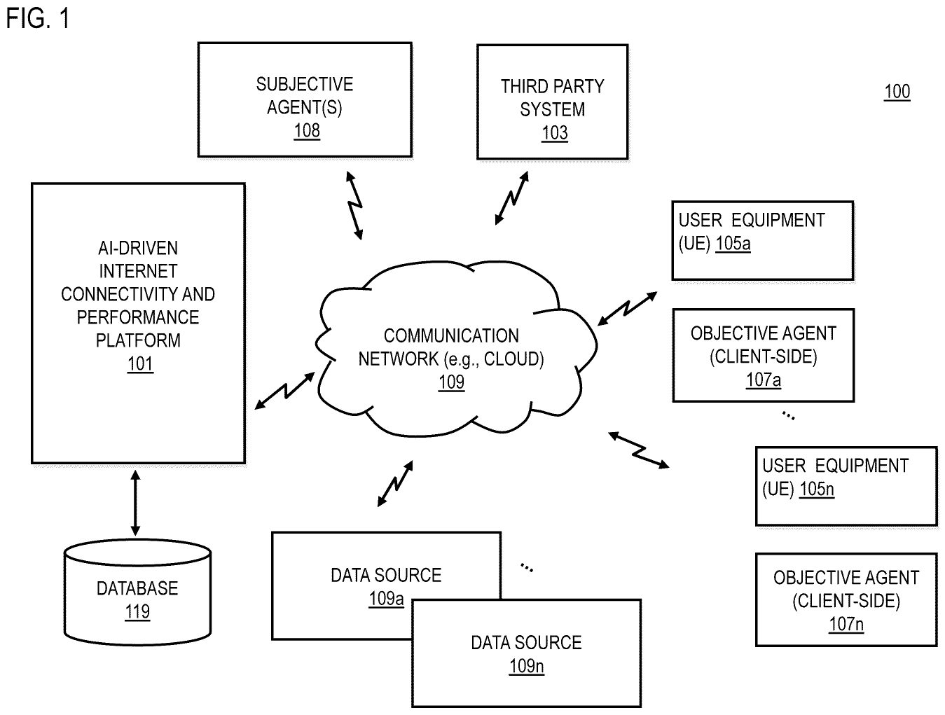

FIG. 1 is a diagram of an Artificial Intelligence (AI)-driven Internet connectivity and performance platform, according to one embodiment. As noted, Internet service quality continues to be measured using fragmented and narrowly scoped key performance indicators (KPIs), which fail to provide a comprehensive view of user experience. While objective data collection has improved through embedded test agents and network monitoring tools, conventional systems do not integrate these signals with end-user sentiment or contextual insights, limiting their diagnostic value. To address the noted drawbacks of conventional systems and approaches to integrating objective data from IoT and network monitoring systems with subjective customer feedback to determine network performance and user satisfaction, a system 100 of FIG. 1 includes an AI-driven Internet connectivity and performance platform 101 that introduces the capability to establish a long-term benchmark for connected performance, independent of network, wireless technology (e.g., WI-FI), or service. Although the platform 101 is explained utilizing use cases involving wireless technologies, it is contemplated that the platform 101 can be applied to other communication technologies, such as terrestrial, and satellite networks.

According to various embodiments, the platform 101 extends Internet performance monitoring beyond traditional test and measurement by incorporating advanced techniques in artificial intelligence, specifically through the application of large language models (LLMs). The platform 101 approach advantageously enriches objective data with subjective insights, creating a holistic understanding of the underlying trends and patterns. By leveraging AI and integrating LLMs, the platform 101 bridges the gap between quantitative data and qualitative analysis, enhancing the decision-making process with a nuanced blend of both types of data.

The platform 101 computes a Mean Quality Index (MQI) score that quantifies Internet performance based on objective wireless connection metrics, such as throughput, latency, jitter, and packet loss. The platform 101 collects these connection parameters via one or more objective agents and computes the MQI score using deterministic logic. Additionally, the platform 101 extracts user sentiment data from textual sources including, for example, online reviews and support interactions. A transformer-based artificial intelligence (AI) model analyzes the textual feedback and generates a Sentiment Momentum (SM) score. The SM score is used to annotate, adjust, or qualify the MQI score. The refined score, combining both objective and subjective indicators, is then output for use in diagnostics, alerting, or performance benchmarking across devices, venues, or time periods.

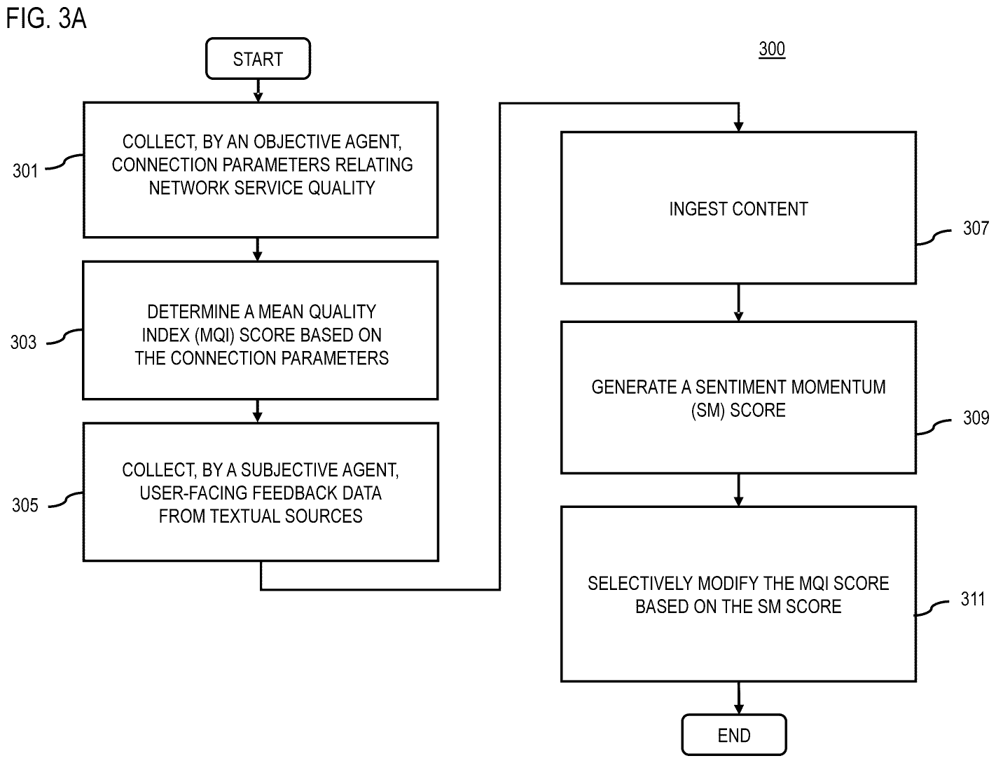

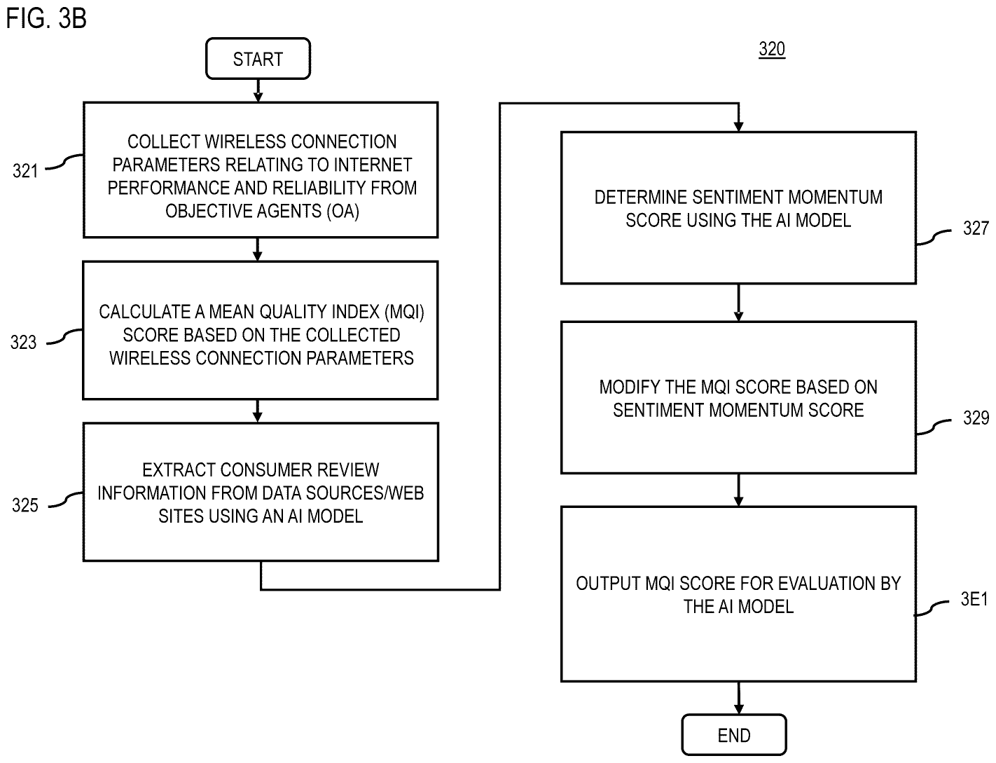

As shown in FIG. 1, the system 100 also comprises user equipment (UE) 105a-105n (collectively referred to as UE 105) that may include or be associated with applicationsa-107n (collectively referred to as applications). In one embodiment, the UE 105 has connectivity to the AI-driven Internet connectivity and performance platform 101 via the communication network 109. Under certain scenarios, the AI-driven Internet connectivity and performance platform 101 performs one or more functions associated with determining connection and Internet reliability and performance in conjunction with one or more Objective Agents (OAs) 107a-107n, which are executed by computers residing on the client side (e.g., at “venue asset” or premise) and one or more Subjective Agents (SAs) 108. In one embodiment, an OA on the server-side (not shown) is utilized to communicate with client-side OAs 107a-107n. It is noted that, according to one embodiment, the platform 101 itself can contain the functionality of an SA. Data collected by the OAs 107a-107n and SAs 108 are used to generate a Mean Quality Index (MQI) score (which is further detailed in FIG. 3).

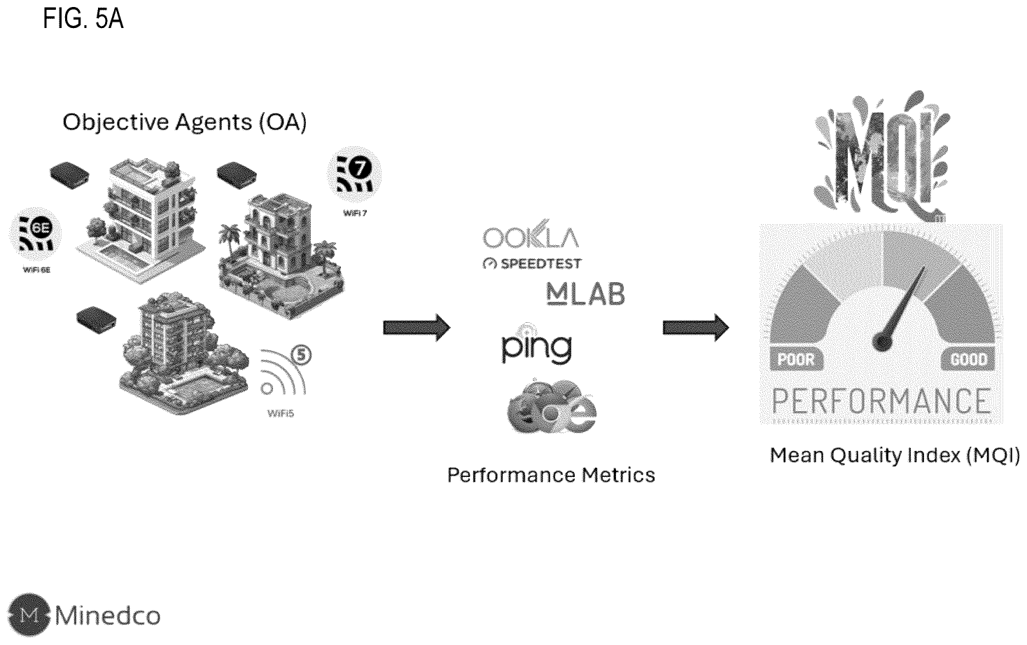

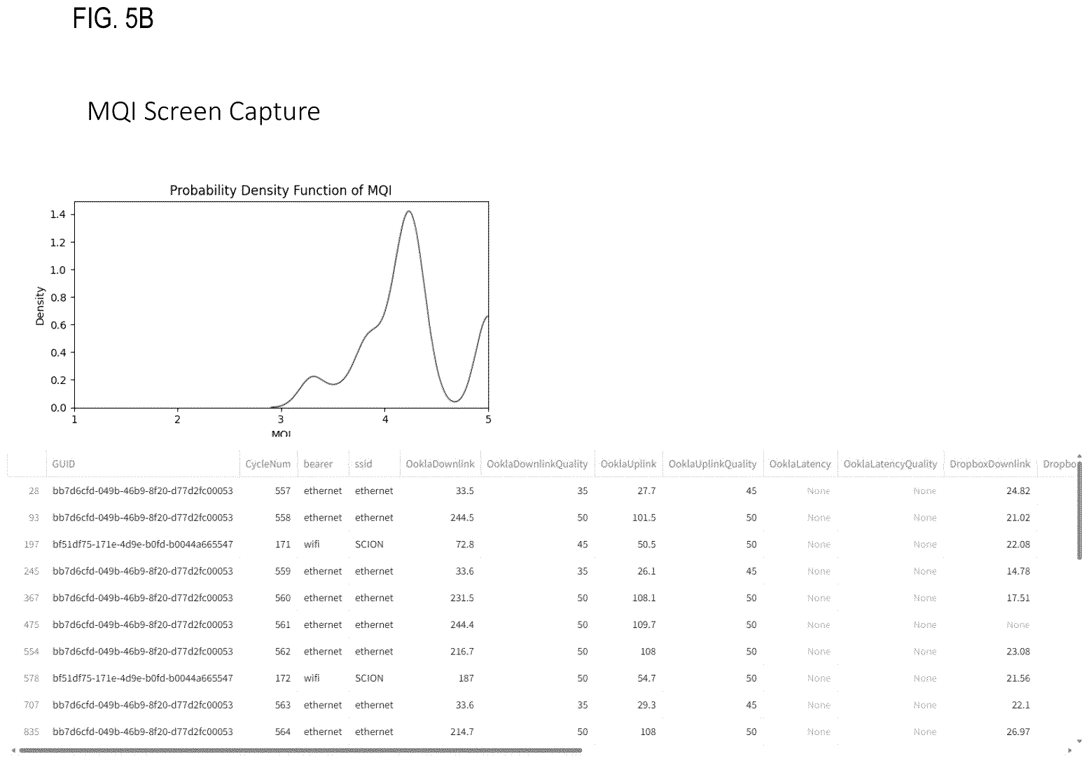

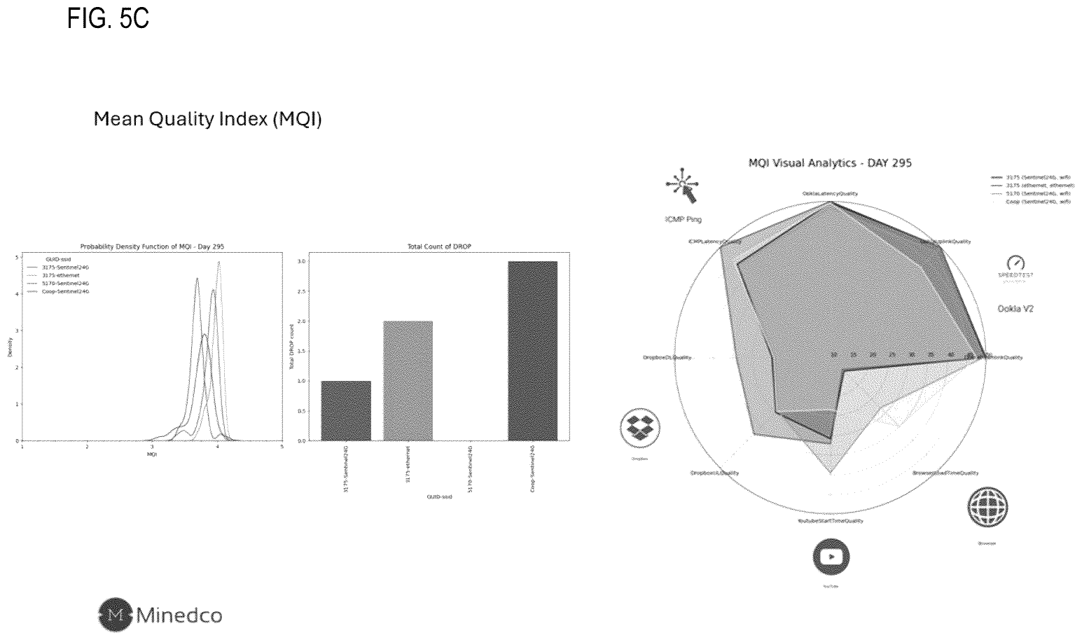

By way of example, the UE 105 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, a smartphone, a smartwatch, smart eyewear, or any combination thereof, including the accessories and peripherals of these devices, or any combination thereof. It is also contemplated that the UE 105 can support any type of interface to the user (such as “wearable” circuitry, etc.). In one embodiment, the UE 105 may include Global Positioning System (GPS) receivers to obtain geographic coordinates from satellites (not shown) for determining current location and time associated with the UE 105; such GPS information can be utilized to geo-tag images captured by UE sensors (not shown). The UE 105 is capable of supporting a graphical user interface (GUI) that provides the GUI of FIGS. 5B, 6A, 6B, and 7.

The AI-driven Internet connectivity and performance platform 101 operates in conjunction with one or more applications (not shown) resident on an UE 105. By way of example, the applications, which can include the OAs 107, may be any type of application that is executable at UE 105, such as content provisioning services, camera/imaging application, media player applications, social networking applications, calendar applications, and the like. In one embodiment, the applications may assist in conveying sensor information via the communication network 109. In another embodiment, one of the applications at the UE 105 may act as a client for the AI-driven Internet connectivity and performance platform 101 and perform one or more functions associated with the functions of the platform 113 by interacting with the platform 113 over the communication network 109.

One or more data sources 109a-109n are accessible via the network 109 by the platform 101. The data sources 109a-109n can include websites or any source for consumer feedback relating to Internet connectivity (as shown in FIG. 3). The retrieved data can reside within database 111 of the AI-driven Internet connectivity and performance platform 101. It is contemplated that database 111 can be implemented as a cloud storage system.

The communication network 109 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including 5G (5^{th} Generation), 4G, 3G, 2G, Long Term Evolution (LTE), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, the AI-driven Internet connectivity and performance platform 101 may be a platform with multiple interconnected components. The AI-driven Internet connectivity and performance platform 101 may include multiple servers, intelligent networking devices, computing devices, components and corresponding software for providing real-time data analysis. In addition, it is noted that the AI-driven Internet connectivity and performance platform 101 may be integrated or separated from services platform. Also, certain functionalities of the system 101 may reside within the UE 105 (e.g., as part of the applications).

Moreover, the platform 101 can interface with various services systems (not shown), such as notification services, content (e.g., audio, video, images, etc.) provisioning services, application services, storage services, contextual information determination services, social networking services, location-based services, information-based services, etc.

By way of example, UE 105, the AI-driven Internet connectivity and performance platform 101, the third party system 103 with each other and other components of the communication network 109 using well known, new or still developing protocols (e.g., IoT standards and protocols). In this context, a protocol includes a set of rules defining how the network nodes within the communication network 109 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

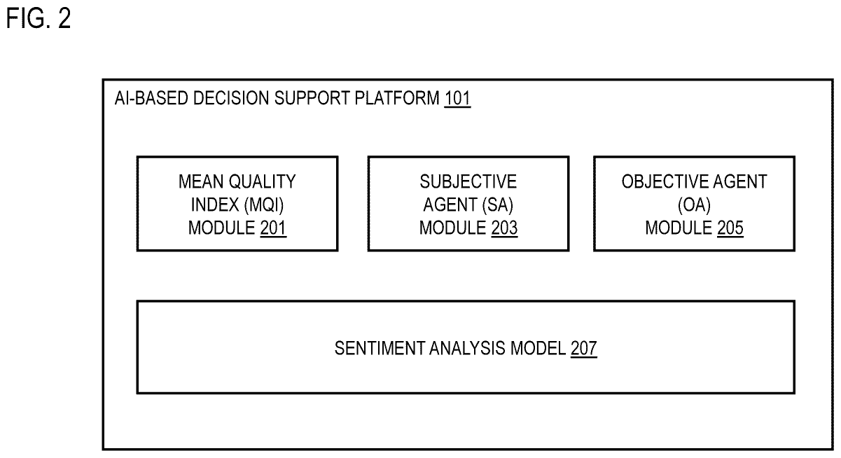

FIG. 2 is a diagram of the components of the AI-driven Internet connectivity and performance platform of FIG. 1, according to one embodiment. As noted, conventional approaches have not correlated objective data (e.g., from IoT and network monitoring systems) with subjective customer feedback in a meaningful way. Such disconnect limits the ability of service providers (e.g., businesses) to respond effectively to customer needs and improve service quality. The platform 101 utilizes AI and machine learning (ML) to actively measure network (e.g., Internet) performance (i.e., “the online experience”) and to respond to social media claims from a quantitative and qualitative perspective.

By way of example, the platform 101 includes one or more components for analyzing data to determine MQI and associated benchmark. That is, the platform 101 provides for computing, visualizing, and enhancing a quantitative index of network (e.g., Internet) performance referred. It is contemplated that the functions of these components may be combined in one or more components or performed by other components of equivalent functionality. In this embodiment, the AI-driven Internet connectivity and performance platform 101 includes the following modules: a Mean Quality Index (MQI) module 201, a Subjective Agent (SA) module 203, a Objective Agent (OA) module 205, and a Sentiment Analysis Model 207. The Sentiment Analysis Model 207, according to one embodiment, is implemented as a transformer-based large language model (LLM).

Objective Agents 107a may operate in customer premises equipment (e.g., routers, Raspberry Pi probes, mobile apps) and collect key performance indicators (KPIs), including but not limited to: download throughput, upload throughput, latency, jitter, packet loss, Domain Name System (DNS) resolution speed, and TCP session set-up time. These metrics are periodically transmitted to the MQI module 201 in structured formats.

In some embodiments, the Objective Agents 107a may be implemented as containerized network diagnostic nodes running on open-source platforms. For example, a Scorephia-branded diagnostic unit (internally referred to as “mbot”) may be deployed on an Ubuntu Linux™ system utilizing Docker. These units incorporate open-source measurement tools (e.g., based on the Murakami™ framework) to perform structured tests across access types, including Wi-Fi 6 and Wi-Fi 7. The collected KPIs are automatically transmitted in JSON format to the processing platform for MQI computation.

Subjective Agents 108 interface with text-based data sources such as online customer reviews, support ticket transcripts, chat logs, survey forms, and help desk or social media forums. These inputs are ingested and preprocessed using natural language processing (NLP) techniques. In parallel, Subjective Agents 108 may be configured to target the same venue or geographic region by monitoring publicly available review platforms such as Google™ Reviews, Yelp™, and other customer feedback repositories. These agents ingest unstructured textual data that can be linked, tagged, or aligned to the corresponding objective test site or device ID, thereby supporting cross-validation between perceived and actual quality of experience.

The MQI module 201, according to one embodiment, utilizes a deterministic algorithm used to generate a Mean Quality Index “score” on an absolute scale—e.g., 1.0 through 5.0, where 5.0 is perfect and 1.0 is a useless connected experience. By way of example, MQI is a single variable which provides for regression testing analytics to establish a long-term benchmark for connected performance, independent of network, WI-FI technology, or service.

The MQI is computed by aggregating and normalizing a plurality of objective performance parameters, including but not limited to: download throughput, upload throughput, latency, jitter, and packet loss. The MQI is represented as a continuous score on a fixed interval scale (e.g., 1.0 to 5.0), with 5.0 representing optimal connectivity and 1.0 representing unusable or degraded service. In certain implementations, the score may be computed using deterministic formulas or statistical mappings embodied in accompanying source code or illustrative scripts. The computation is based on statistical transformations and weighted mappings. The score may be generated using formulas or statistical mappings defined in accompanying source code or illustrative scripts, such as mqi2csv-newer24.py or mqi2csv-newer24-mlab.py.

In preferred embodiments, the MQI score is not derived from isolated KPIs but from a clustered battery of tests—such as throughput measurements (e.g., Murakami™ NDT7 or Ookla™ speed test), browser-based page loads, Dropbox™ file transfers, Internet Control Message Protocol (ICMP) ping, and jitter-designed to emulate a real end-user's composite online experience.

In certain embodiments, the MQI score is computed entirely through deterministic logic and statistical operations performed on data acquired from one or more objective agents (OAs) 107, which may be implemented as embedded test agents, software agents, or standalone diagnostic appliances.

In further embodiments, the MQI score is optionally enhanced or annotated through a SA Module 203 that integrates data derived from subjective agents (SAs). These SAs may retrieve or ingest user reviews, support transcripts, chat logs, or other textual or sentiment-bearing sources. A transformer-based natural language processing model, such as a large language model (LLM), is employed to derive a Sentiment Momentum (SM) score from the subjective inputs. The transformer-based AI model (e.g., LLM or fine-tuned BERT derivative) parses the textual content and produces a Sentiment Momentum (SM) score. SM quantifies sentiment polarity over time and is optionally mapped to a fixed interval scale. In some embodiments, the SM score is used to annotate or weight the baseline MQI score. In certain embodiments, the refined MQI score may be annotated rather than adjusted. Additional scoring layers, AI models, or signal modifiers may be incorporated, allowing extensibility for future implementations.

The SA module 203, in certain embodiments, is a server-side, AI application that extracts reviews from any public website, defined by the user, in the form of text, for the venue, property, or asset of interest (ASSET). Through AI and the application of large language models (LLMs), the SA module 203 ‘reads’ the extracted text (e.g., from online reviews, online search, and/or other online forums, etc.) per (ASSET) to derive sentiment, among other insights, from the text. According to various embodiments, the MQI is calculated from objective measurements and subjective measurements gathered and evaluated by the Sentiment Analysis model 207.

The SM score may be used to adjust, flag, or otherwise qualify the MQI score, yielding a refined index that incorporates both deterministic and subjective indicators of quality. This two-layered approach enables operators, regulators, and support teams to interpret anomalies, trends, and outliers in network performance across hardware, geography, and time.

The described dual-scoring approach allows network operators and venue owners to evaluate service quality based on both objective performance and subjective perception. For example, an area may show high MQI score but declining SM, signaling a perception gap that may require proactive customer engagement.

As noted, the platform 101 can include an Objective Agent (OA) module 205 (on the server-side) to communicate with the client-side OAs 107, which transmit, for instance, WI-FI performance metrics back to a server-side OA module 205 for analysis. The MQI score is generated using the metrics collected from the OAs 107.

In one embodiment, two diagnostic agents are deployed at the same physical site—e.g., one connected via Wi-Fi and another via Ethernet. These agents perform multiple tests in temporal proximity, including speed tests (e.g., Murakami™ NDT7 or Ookla™), ICMP ping, browser load speed, Dropbox™ transfers, jitter measurement, and YouTube™ streaming playback diagnostics.

The platform 101 may be implemented as a containerized service (e.g., Docker™), deployed via Kubernetes or serverless functions. The platform 101 may interface with PostgreSQL or NoSQL databases for telemetry and metadata, TensorFlow™, PyTorch™, or ONNX™ runtimes for model inference, and APIs for third-party dashboard or support tool integrations. Agent communication occurs over encrypted channels, with optional token-based or certificate-based authentication.

According to certain embodiments, the platform 101 maintains self-calibration routines: baseline comparison over time, drift detection in sentiment or performance, and model retraining pipelines (e.g., with SM feedback loops). These features enable autonomous debugging or alerting workflows triggered by score deltas or detected anomalies.

The processes of platform 101 is platform-agnostic and may be deployed across various hardware form factors, including Raspberry Pi™, Android™ Open Source Platform (AOSP) agents, venue-integrated access points, or cloud-based diagnostic nodes. It may further support data visualization through diagnostic tools (e.g., radar plots, density plots, etc.) and reporting modules. The MQI framework can be utilized for diagnostics, benchmarking, and user-facing performance intelligence across enterprise and consumer network environments.

The MQI framework provides for aggregating performance metrics across a multimodal test suite executed in close temporal proximity to emulate realistic user workflows. A single test instance may include throughput benchmarking (e.g., Murakami™ NDT5, NDT7 or Ookla™ speed test), browser-based page load simulations, Dropbox™ upload/download transactions, YouTube™ streaming playback diagnostics, ICMP ping tests for latency, and jitter analysis. Each subtest is initiated and recorded by the same objective agent within a bounded session window. The resulting metrics are analyzed collectively rather than in isolation, enabling the system to score perceived performance from the end-user's perspective. This clustered testing strategy underpins the integrity of the MQI, yielding a reproducible and context-aware score that reflects actual connectivity experience rather than isolated network KPIs.

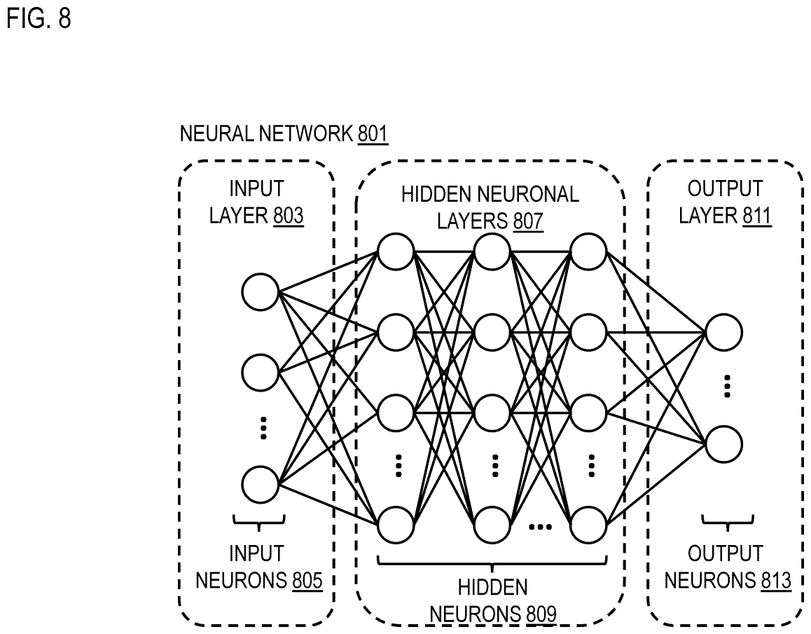

The Sentiment Analysis Model 207 interact with one or more of the various modules 201-205 to support the functions of the platform 101. By way of example, the model 207 can execute the neural network of FIG. 8.

Results from each test session are uploaded to a cloud-based object store (e.g., Google™ Cloud Storage or Amazon™ S3). The platform 101 monitors this store and automatically retrieves new datasets for scoring. MQI values, diagnostic metadata, and optional sentiment overlays are stored in a managed database backend (e.g., PostgreSQL or equivalent) to support historical tracking, anomaly detection, and longitudinal reporting.

The above presented modules and components of the AI-driven Internet connectivity and performance platform 101 can be implemented in hardware, firmware, software, or a combination thereof. The platform 101 may be deployed in cloud, edge, or on-premises configurations. Objective Agents 107 may operate on embedded systems (e.g., firmware-enabled routers), mobile devices with diagnostic SDKs, or custom hardware appliances (e.g., Scorephia boxes). For example, the platform 101 may incorporate neural network chips or co-processors for LLM execution, IoT chipsets with MQTT or CoAP protocol support, and mobile device components (e.g., GPS, modem, DSP) for context-aware data tagging. The platform 101 is compatible with Wi-Fi, Ethernet, LTE, 5G, and other access technologies.

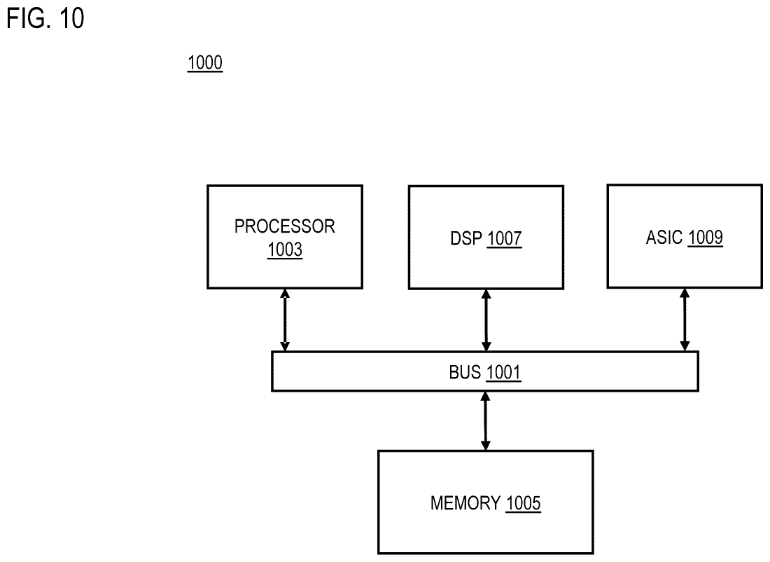

FIGS. 3A and 3B are flowcharts of processes for generating a Mean Quality Index (MQI) by the AI-driven Internet connectivity and performance platform of FIG. 1, according to one embodiment. In one embodiment, the AI-driven Internet connectivity and performance platform 101 performs the processes 300 and 320 and are implemented in, for instance, a chip set including a processor and a memory as shown in FIG. 10.

As shown in FIG. 3A, process 300 includes collecting, by an objective agent, one or more connection parameters relating to network service quality. The objective agent is configured to perform connection diagnostics. The collected connection parameters include throughput measurements relating to download speed and upload speed (as in step 301). Moreover, the connection parameters can also include one or more combination of latency measurement data, jitter metric data, and packet loss measurement data, browser performance metric data, cloud synchronization metric data, and video streaming metric data. With respect to browser performance, such metrics can include measurement of browser load speed, for example. Cloud synchronization metric can, for instance, include upload or download throughput for a storage service such as Dropbox™. In terms of video streaming metric, buffer rate measured during a defined playback can be utilized (e.g., YouTube™).

Per step 303, a mean quality index (MQI) score is determined based on the collected connection parameters, wherein the MQI score is indicative of the network service quality from a user perspective. The determination of the MQI score includes normalizing and weighting the collected connection parameters, and mapping the normalized and weighted connection parameters to a fixed performance scale. In one embodiment, the MQI score is computed from a sequential cluster of tests executed within a defined test session to emulate user activity.

The process 300 also includes collecting, by an subjective agent, user-facing feedback data from one or more textual sources relating to the network service quality. The subjective agent is configured to extract feedback from external sources. The process 320 includes ingesting content, wherein the content includes one or more combination of online review, support transcript, and social media forum, as in step 307. According to one embodiment, the ingesting process can include web scraping or equivalent techniques, such as the following: HTML DOM parsing using predefined selectors, headless browser automation, authenticated API ingestion from user feedback platforms, and text extraction via screenshot Optical Character Recognition (OCR) or plugin-based crawling.

By way of example, the ingested content is processed, according to one embodiment, using a transformer-based large language model to generate a vector signal representing sentiment information over time, wherein the vector signal includes sentiment polarity (e.g., positive/negative/neutral), sentiment magnitude (e.g., strength or amplitude), and sentiment trajectory (e.g., direction or trend across a temporal window). Per step 309, a Sentiment Momentum (SM) score is generated. According to one embodiment, the SM score represents a vectorized model of user sentiment based on the collected user-facing feedback data and the ingested content. In step 311, the process 300 selectively modifies the MQI score based on the generated SM score. In one embodiment, the refinement of the MQI score involves comparing the MQI score to the SM vector signal, determining a discrepancy threshold based on divergence between deterministic performance and sentiment trend, and applying a fusion logic. Such fusion logic includes adjusting the MQI score using a weight derived from the SM signal amplitude; overriding the MQI score if the SM trajectory indicates sustained negative feedback; and annotating the MQI score with a qualitative flag if SM sentiment polarity contradicts the performance classification.

The MQI score can be modified in various ways, such as by adjusting the MQI score numerically based on the SM vector signal, determining that a trajectory of the SM vector signal indicates a negative feedback to override the MQI score, or annotating the MQI score with a qualitative flag based on polarity of the SM vector signal. The scores and SM vector signal can be output to any combination of diagnostic dashboards, reporting Application Programming Interfaces (APIs), alerting engines, and visualization platforms.

Although not shown, the process 300 can include presenting, via a graphical user interface (GUI), one or more visualizations including one or more combinations of a radar plot depicting multidimensional KPIs, a kernel graph indicating statistical distribution of MQI scores, a cohort comparison chart segmented by time, device type, or access type, and a trendline depicting score progression across a plurality of measurement windows. The cohort comparison can include segmentation by, for example, Wi-Fi versus Ethernet modality, location, time-of-day, or peer group classification. The radar plot provides more than a static visualization by enabling a unified and glanceable interpretation of multidimensional KPIs across modalities (e.g., Wi-Fi vs. Ethernet), time slices, and cohort groups. This allows operators to detect anomalies, prioritize support actions, and track longitudinal trends efficiently.

In another embodiment, shown in FIG. 3B, process 320 provides an alternate method for generating the MQI score. Per step 321, wireless connection parameters relating to Internet performance and reliability are collected from one or more OAs 107. In step 303, a MQI score is calculated based on the collected wireless connection parameters. Consumer review information is extracted from one or more data sources using an artificial intelligence (AI) model (i.e., Sentiment Analysis Model), as in step 305. Per step 307, sentiment momentum score is determined using the AI model. In step 309, the MQI score is modified based on the sentiment momentum score. The modified MQI score, per step 311, is output for evaluation by the AI model.

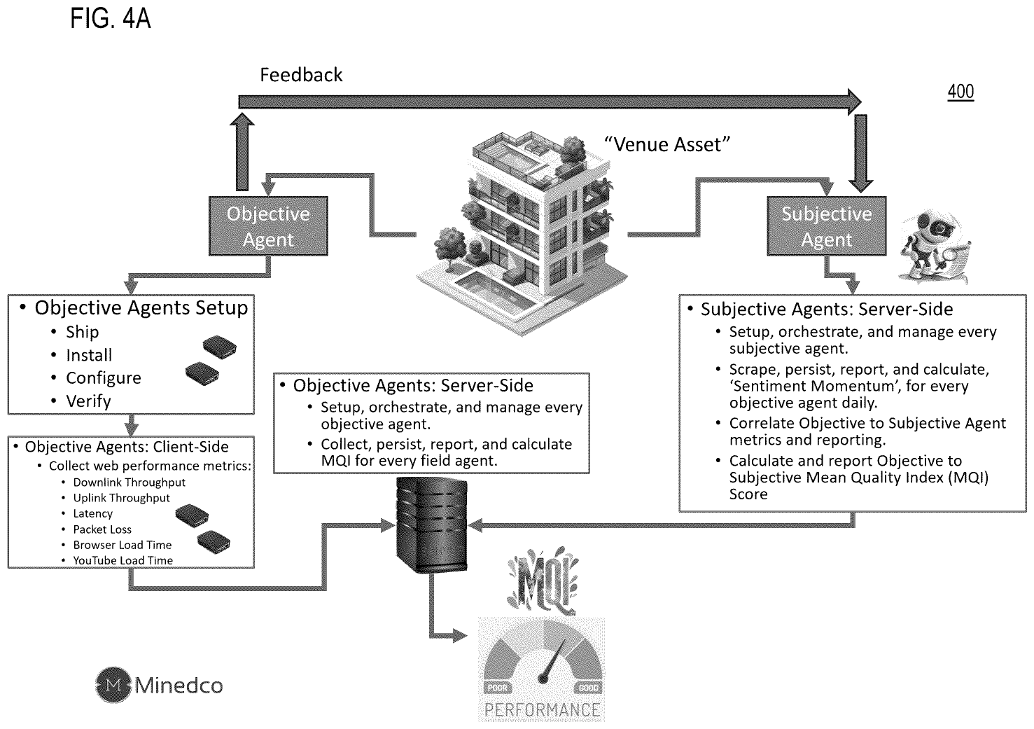

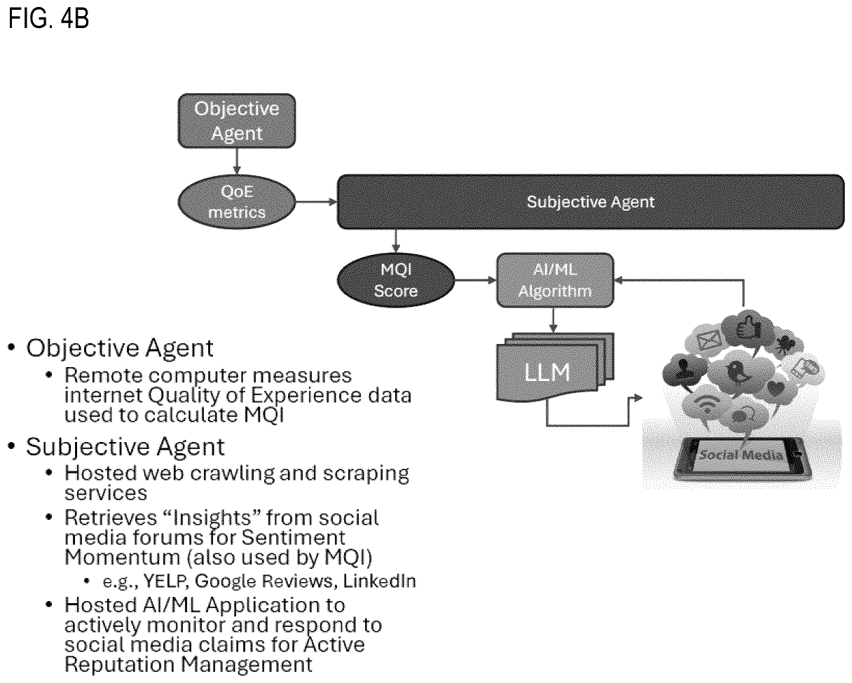

FIGS. 4A and 4B are diagrams of the functional flow among the objective agents (OAs) and subjective agents (SAs), according to various embodiments. Under the scenarios shown in FIGS. 4A and 4B, if Internet forums report high instances of poor Internet performance (complaints), but the objective agents are reporting consistent good internet performance, then the subjective agent can “actively respond to the forums for additional feedback.” The feedback loop leverages LLM and NLP RAG (Retrieval Augmented Generation) to “actively generate a response and post it to the forum for additional feedback.” As such, the platform 101 leverages LLM, NLP, and RAG to actively respond, interrogate, and actively debug edge case trouble tickets or customer complaint scenarios.

FIGS. 5A-5C are diagrams relating to MQI generated by the AI-driven Internet connectivity and performance platform of FIG. 1, according to one embodiment. The generated scores (standalone or fused) are rendered in diagnostics layer using radar plots, kernel density curves, cohort comparisons, and time-series visualizations. Visual outputs include radar plots that represent a normalized breakdown of component KPIs, kernel density graphs for statistical distribution visualization, and comparative diagnostics that enable operators to analyze performance by day, by cohort, or across connection modalities (e.g., Wi-Fi vs. Ethernet). These views enable performance-at-a-glance interpretation and are integral to dashboard-driven troubleshooting and capacity planning.

In certain embodiments, the radar plot not only visualizes individual KPIs but also synthesizes them into a unified diagnostic surface, enabling users to perceive network quality, stability, and modality-driven variations (e.g., Wi-Fi vs Ethernet) at a glance. This graphical integration supports real-time diagnostics, comparative assessment, and trend analysis with minimal interpretation overhead. In one embodiment, the radar visualization plots axis values from a cluster of heterogeneous tests executed during a contiguous test session—the axis values includes one or more combinations of throughput, browser load, and video streaming latency.

The radar plot provides an at-a-glance composite view of the MQI's underlying metrics. Its star-shaped structure visually conveys the balance or imbalance across key performance attributes (e.g., speed, latency, jitter), offering a diagnostic tool that blends interpretability with precision. This graphical format improves pattern recognition and supports faster operator response.

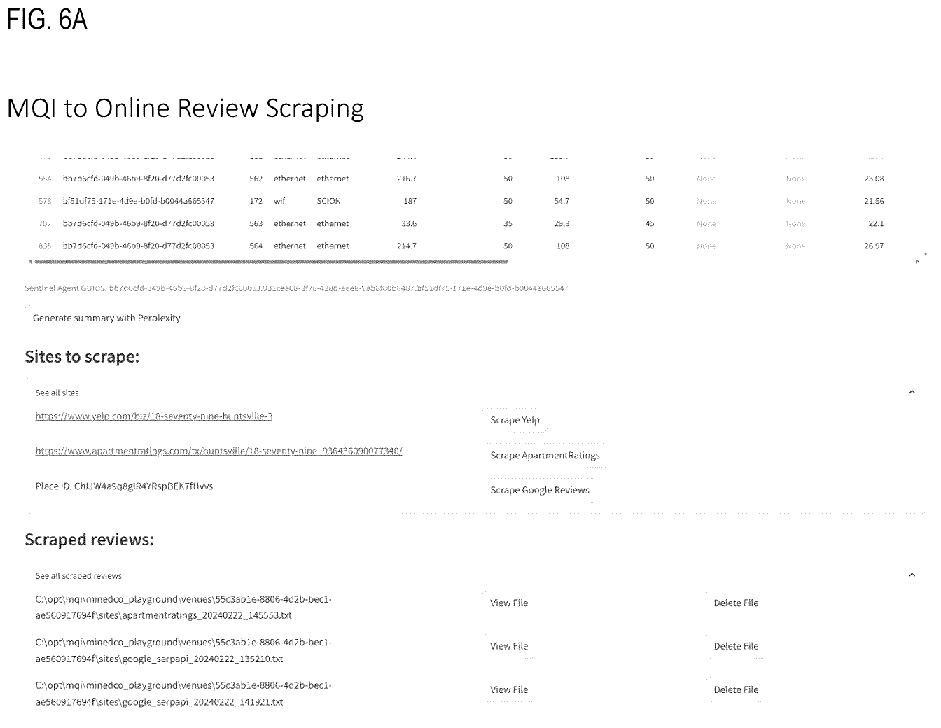

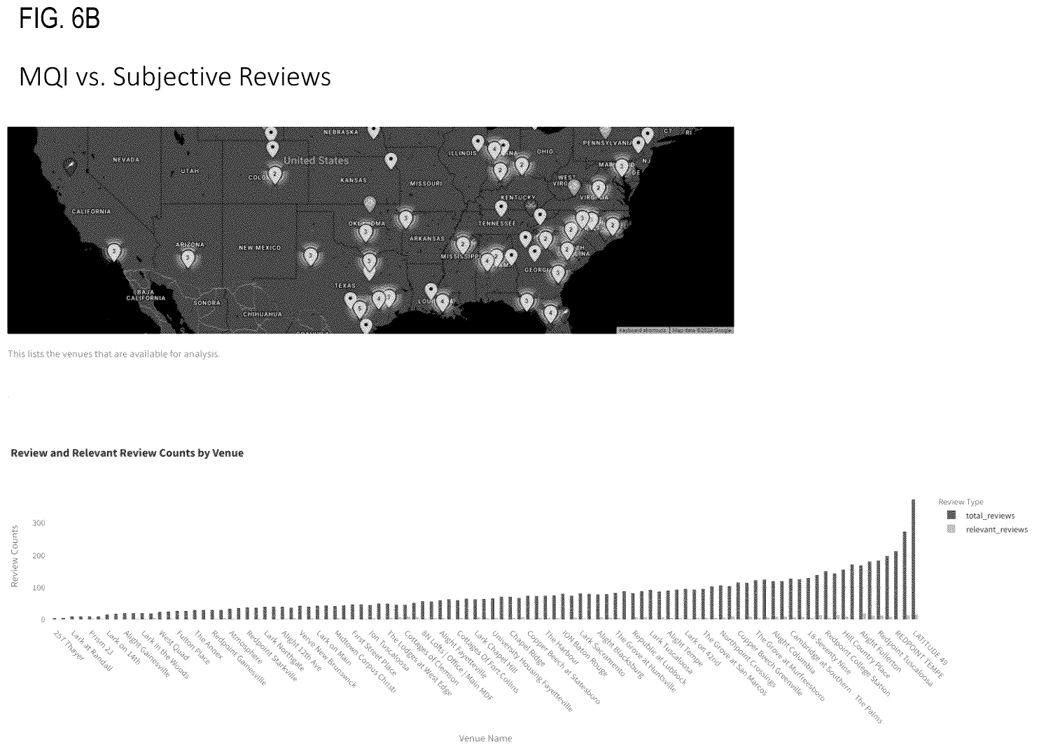

FIGS. 6A and 6B are diagrams of a GUI relating to MQI to online review scraping and MQI versus subjective reviews, respectively, according to one embodiment. The platform 101 provides a cohort benchmarking engine, wherein scores are grouped by venue, device type, network access type (e.g., Wi-Fi vs. Ethernet), and time of day (e.g., peak vs. off-peak). This enables identification of performance anomalies tied to specific mediums (e.g., Wi-Fi degradation during busy hours, while Ethernet remains stable).

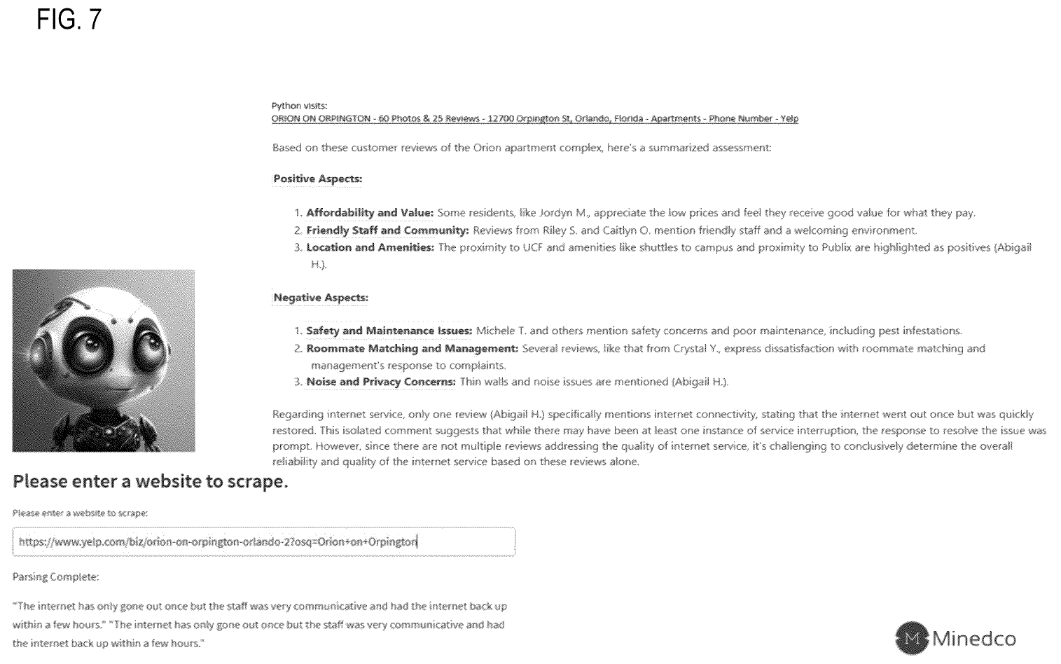

FIG. 7 is a diagram of a GUI relating to the subjective agent (SA) generating a sentiment score, according to one embodiment.

FIG. 8 illustrates an example neural network 801 (e.g., an example of the AI engine 207 implementing a machine learning model) that has an architecture including an input layer 803 comprising one or more input neurons 805, one or more hidden neuronal layers 807 comprising one or more hidden neurons 809, and an output layer 811 comprising one or more output neurons. In one embodiment, the architecture of the neural network 801 refers to the number of input neurons 805, the number of neuronal layers 807, the number of hidden neurons 809 in the neuronal layers 807, the number of output neurons, or a combination thereof. In addition, the architecture can refer to the activation function used by the neurons, the loss functions applied to train the neural network 801, parameters indicating whether the layers are fully connected (e.g., all neurons of one layer are connected to all neurons of another layer) or partially connected, and/or other equivalent characteristics, parameters, or properties of the neurons 805/809/813, neuronal layers 807, or neural network 801. Although the various embodiments described herein are discussed with respect to a neural network 801, it is contemplated that the various embodiments described herein are applicable to any type of machine learning model 109 that can be migrated between different architectures.

In one embodiment, the progressive path migrates an old architecture of a machine learning model 109 into a new architecture by incrementally adding and removing single neurons or neuronal layers, or smoothly changing activation functions in a fashion which does not affect performance of the machine learning model 109 by more than a designated performance change threshold. For example, a user may wish to migrate a machine learning model 109 from an architecture that has three hidden neuronal layers 807 with four hidden neurons 809 in each layer to a new architecture that has four hidden neuronal layers 807 with four hidden neurons 809 each. The machine learning model 109 has been trained using the old architecture for a significant period of time. To advantageously preserve the training already performed and maintain model performance at a target level, the system 100 can construct a progressive path with four steps that incremental adds one hidden neuron 809 to the new neuronal layer 807 at each step until the full new neuronal layer 807 is added. In other words, while the machine learning model 109 of the machine learning system 107 is being trained, a new technical solution or architecture may be discovered that can provide improvements to the machine learning model 109 or system 107. Then instead of replacing the old system architecture in a cut-off fashion, the system 100 can construct incremental steps that can be used to progressively migrate the existing trained machine learning model 109 to avoid catastrophic degradation of the trained machine learning model 109's performance.

In one embodiment, while the progressive migration is being done, the training process continues. In this way, the newly added neurons learn relatively quickly their new roles in the machine learning model 109 as their context environment consists of neuronal layers 807 which already know their jobs (e.g., neuronal layers 807 with neurons 809 that have undergone at least some training). After migration the resulting machine learning model 109 has incorporated expert knowledge from the old architecture, but has a new architecture, new technologies incorporated, and/or the like which can potentially improve the performance and learning of the machine learning model 109 in the future. Accordingly, the embodiments of the system 100 described herein provide technical advantages including, but not limited to, providing long-lived machine learning systems 107 that can be trained better while incorporating new advances in machine learning technologies (e.g., neural network technologies).

The processes described herein for providing decision support may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

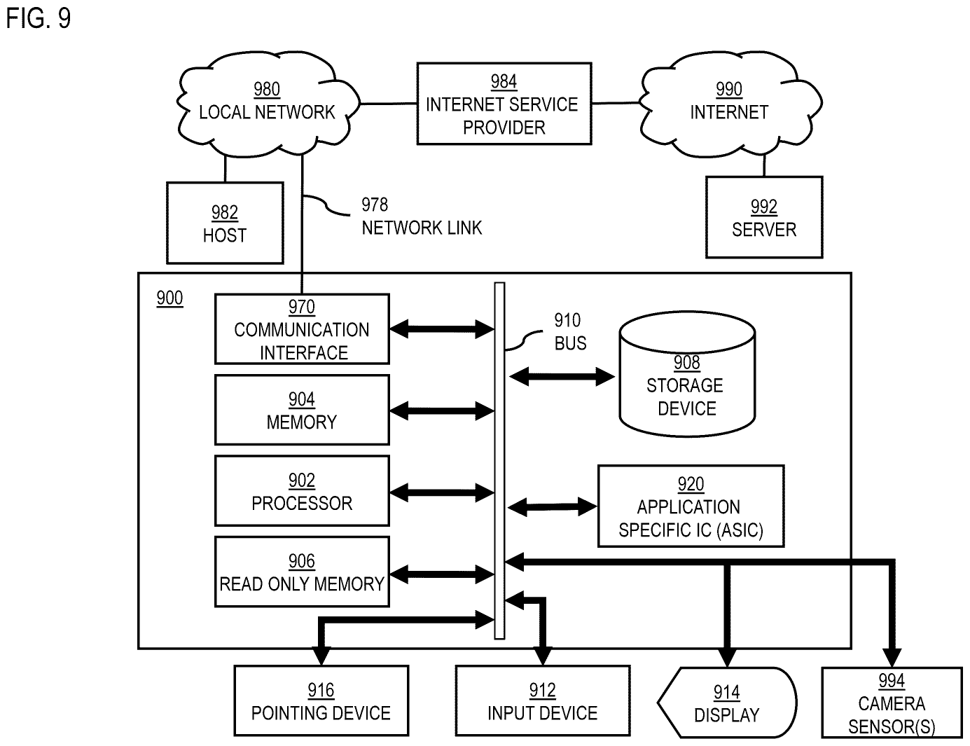

FIG. 9 illustrates a computer system 900 upon which various embodiments of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to provide decision support as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of the processes described herein, including that of FIG. 3.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to providing decision support. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical, or quantum components, among others, alone or in combination.

Computer system 900 also includes a memory 904 coupled to bus 910. The memory 904, such as a random access memory (RAM) or any other dynamic storage device, stores information including processor instructions for providing real-time data analysis to support decision making. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for providing real-time data analysis to support decision making, at least in part, on analysis of collected information, is provided to the bus 910 for use by the processor from an external input device 912, such as a keyboard containing alphanumeric keys operated by a human user, a microphone, an Infrared (IR) remote control, a joystick, a game pad, a stylus pen, a touch screen, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a vacuum fluorescent display (VFD), a liquid crystal display (LCD), a light-emitting diode (LED), an organic light-emitting diode (OLED), a quantum dot display, a virtual reality (VR) headset, a plasma screen, a cathode ray tube (CRT), or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914, and one or more camera sensors 994 for capturing, recording and causing to store one or more still and/or moving images (e.g., videos, movies, etc.) which also may comprise audio recordings. In some embodiments, for example, in embodiments in which the computer system 900 performs all functions automatically without human input, one or more of external input device 912, a display device 914 and pointing device 916 may be omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general, the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 97 in support of the AI-driven Internet connectivity and performance platform 101.

The term “computer-readable medium” as used herein refers to any medium that participates in providing information to processor 902, including instructions for execution. Such a medium may take many forms, including, but not limited to a computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which various embodiments of the invention may be implemented. Chip set 1000 is programmed to the processes (e.g., FIG. 3) as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of providing decision support.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to provide providing decision support. The memory 1005 also stores the data associated with or generated by the execution of the inventive steps.

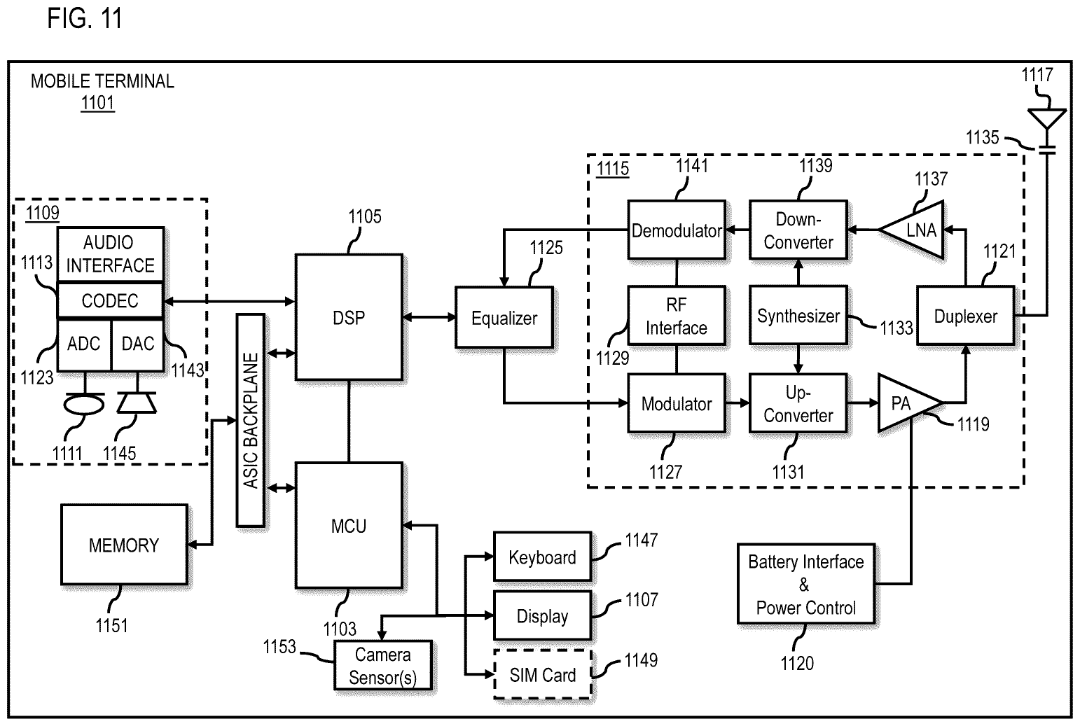

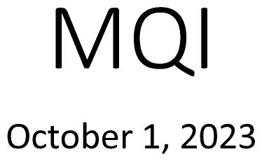

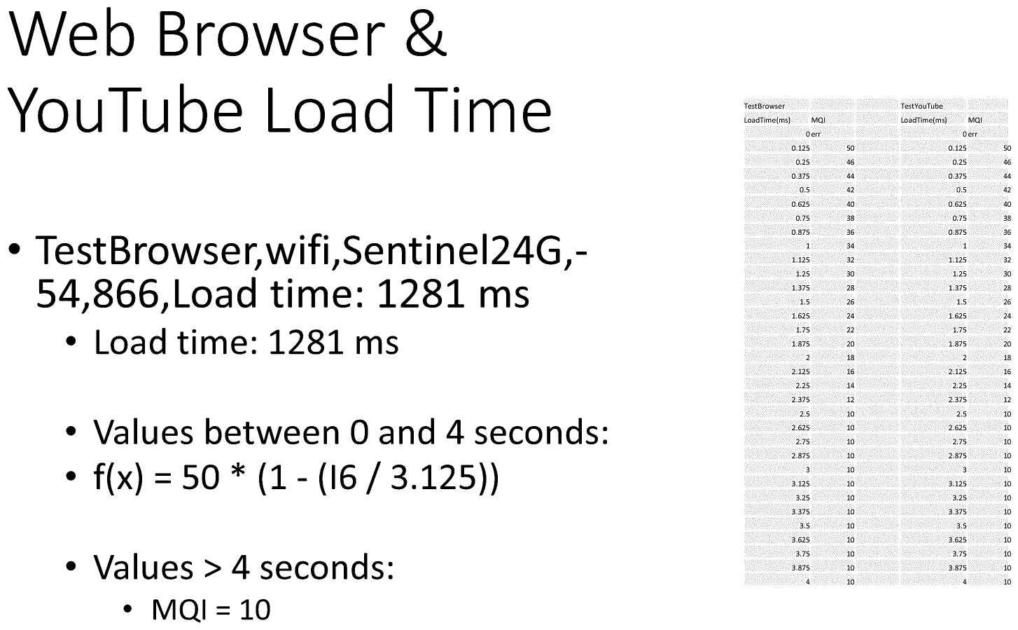

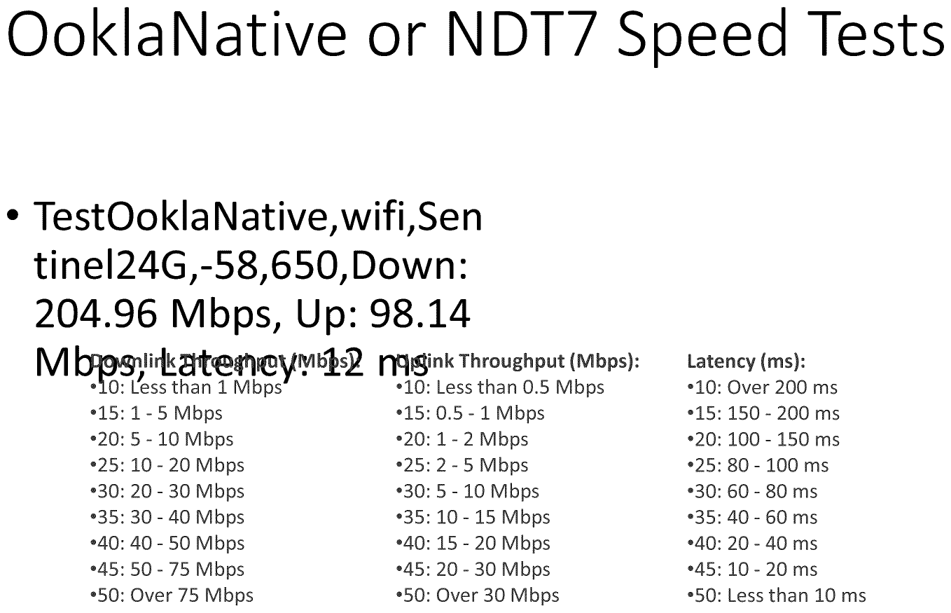

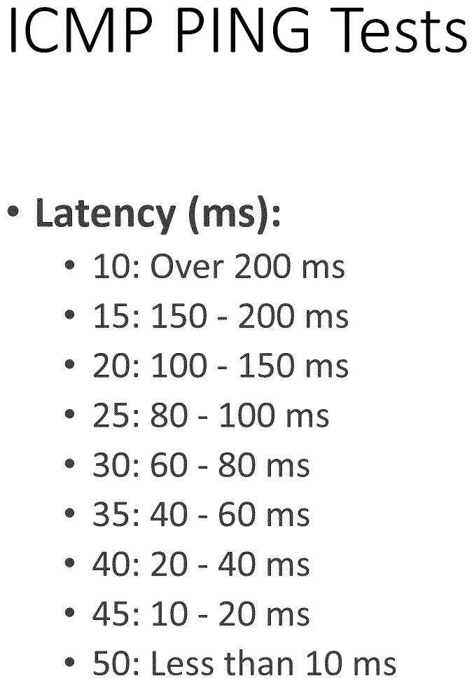

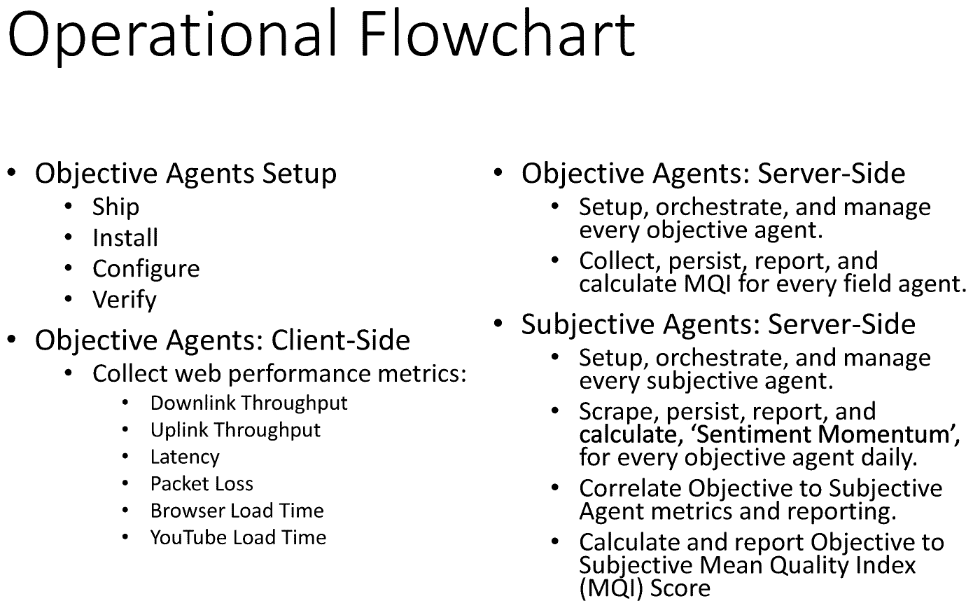

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of the described processes. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of providing decision support. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies the power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with an RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to provide decision support. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Further, one or more camera sensors 1153 may be incorporated onto the mobile station 1101 wherein the one or more camera sensors may be placed at one or more locations on the mobile station. Generally, the camera sensors may be utilized to capture, record, and cause to store one or more still and/or moving images (e.g., videos, movies, etc.) which also may comprise audio recordings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. A method comprising:
collecting, by at least one objective agent, a plurality of connection parameters relating to network service quality, wherein the plurality of collected connection parameters include throughput measurements relating to download speed and upload speed; and
determining a mean quality index (MQI) score based on the plurality of collected connection parameters, wherein the MQI score is indicative of the network service quality from a user perspective,
wherein the determination of the MQI score includes normalizing and weighting the plurality of collected connection parameters, and mapping the normalized and weighted connection parameters to a fixed performance scale.

2. The method of claim 1, further comprising:
generating a Sentiment Momentum (SM) score representing a vectorized model of user sentiment, wherein the generation of the SM score includes
collecting, by at least one subjective agent, user-facing feedback data from one or more textual sources, and
ingesting content, wherein the content includes one or more combination of online review, support transcript, and social media forum; and
selectively modifying the MQI score based on the generated SM score.

3. The method of claim 2, further comprising:
processing the ingested content using a transformer-based large language model to generate a vector signal representing sentiment information over time, wherein the vector signal includes sentiment polarity, sentiment magnitude, and sentiment trajectory.
collecting, by at least one subjective agent, user-facing feedback data from one or more textual sources, and
ingesting content, wherein the content includes one or more combination of online review, support transcript, and social media forum; and

4. The method of claim 3, further comprising:
adjusting the MQI score numerically based on the SM vector signal; or
determining that a trajectory of the SM vector signal indicates a negative feedback to override the MQI score; or
annotating the MQI score with a qualitative flag based on polarity of the SM vector signal.

5. The method of claim 3, further comprising:
presenting, via a graphical user interface, one or more visualizations including one or more combinations of a radar plot depicting multidimensional Key Performance Indicators (KPI), a kernel graph indicating statistical distribution of MQI scores, a cohort comparison chart segmented by time, device type, or access type, and a trendline depicting score progression across a plurality of measurement windows.

6. The method of claim 1, wherein the MQI score is computed from a sequential cluster of tests executed within a defined test session to emulate user activity.

7. The method of claim 1, wherein the connection parameters include one or more combination of latency measurement data, jitter metric data, and packet loss measurement data, browser performance metric data, cloud synchronization metric data, and video streaming metric data.

8. A method of comprising:
collecting, by at least one subjective agent, user-facing feedback data from one or more textual sources relating to network service quality;
ingesting content, wherein the content includes one or more combination of online review, support transcript, and social media forum;
generating a Sentiment Momentum (SM) score representing a vectorized model of user sentiment based on the collected user-facing feedback data and the ingested content.

9. The method of claim 8, further comprising:
processing the ingested content using a transformer-based large language model to generate a vector signal representing sentiment information over time, wherein the vector signal includes sentiment polarity, sentiment magnitude, and sentiment trajectory.

10. The method of claim 9, further comprising:
collecting, by at least one objective agent, a plurality of connection parameters relating to the network service quality, wherein the plurality of collected connection parameters include throughput measurements relating to download speed and upload speed; and
determining a mean quality index (MQI) score based on the plurality of collected connection parameters, wherein the MQI score is indicative of the network service quality from a user perspective, wherein the determination of the MQI score includes normalizing and weighting the plurality of collected connection parameters, and mapping the normalized and weighted connection parameters to a fixed performance scale; and
selectively modifying the MQI score based on the generated SM score.

11. The method of claim 10, further comprising:
adjusting the MQI score numerically based on the SM vector signal; or
determining that a trajectory of the SM vector signal indicates a negative feedback to override the MQI score; or
annotating the MQI score with a qualitative flag based on polarity of the SM vector signal.

12. The method of claim 11, further comprising:
presenting, via a graphical user interface, one or more visualizations including one or more combinations of a radar plot depicting multidimensional Key Performance Indicators (KPI), a kernel graph indicating statistical distribution of MQI scores, a cohort comparison chart segmented by time, device type, or access type, and a trendline depicting score progression across a plurality of measurement windows.

13. The method of claim 12, wherein the MQI score is computed from a sequential cluster of tests executed within a defined test session to emulate user activity, and the one or more visualizations plots axis values from a cluster of heterogeneous tests executed during a contiguous test session, the axis values including throughput, browser load, and video streaming latency.

14. The method of claim 10, wherein the connection parameters include one or more combination of latency measurement data, jitter metric data, and packet loss measurement data, browser performance metric data, cloud synchronization metric data, and video streaming metric data.

15. A system comprising:
a memory configured to store computer-executable instructions; and
one or more processors configured to execute the instructions to:
collect, by at least one objective agent, a plurality of connection parameters relating to network service quality, wherein the plurality of collected connection parameters include throughput measurements relating to download speed and upload speed;
determine a mean quality index (MQI) score based on the plurality of collected connection parameters, wherein the MQI score is indicative of the network service quality from a user perspective, wherein the determination of the MQI score includes normalizing and weighting the plurality of collected connection parameters, and
mapping the normalized and weighted connection parameters to a fixed performance scale;
collect, by at least one subjective agent, user-facing feedback data from one or more textual sources relating to the network service quality;
ingest content, wherein the content includes one or more combination of online review, support transcript, and social media forum;
generate a Sentiment Momentum (SM) score representing a vectorized model of user sentiment based on the collected user-facing feedback data and the ingested content; and
selectively modify the MQI score based on the generated SM score.

16. The system of claim 15, wherein the one or more processors are further configured to execute the instructions to:
process the ingested content using a transformer-based large language model to generate a vector signal representing sentiment information over time, wherein the vector signal includes sentiment polarity, sentiment magnitude, and sentiment trajectory.

17. The system of claim 16, wherein the one or more processors are further configured to execute the instructions to:
adjust the MQI score numerically based on the SM vector signal; or
determine that a trajectory of the SM vector signal indicates a negative feedback to override the MQI score; or
annotate the MQI score with a qualitative flag based on polarity of the SM vector signal.

18. The system of claim 15, wherein the one or more processors are further configured to execute the instructions to:
present, via a graphical user interface, one or more visualizations including one or more combinations of a radar plot depicting multidimensional Key Performance Indicators (KPI), a kernel graph indicating statistical distribution of MQI scores, a cohort comparison chart segmented by time, device type, or access type, and a trendline depicting score progression across a plurality of measurement windows.

19. The system of claim 15, wherein the MQI score is computed from a sequential cluster of tests executed within a defined test session to emulate user activity.

20. The system of claim 15, wherein the connection parameters include one or more combination of latency measurement data, jitter metric data, and packet loss measurement data, browser performance metric data, cloud synchronization metric data, and video streaming metric data.
